(19) United States
(12) Patent Application Publication
(10) Pub. No.: US 2007/0077924 A1
(43) Pub. Date: Apr. 5, 2007

(54) System and method to locate mobile devices having inaudible settings

(76) Inventors: Kulvir Singh Bhogal, Fort Worth, TX (US); Gregory Jensen Boss, American Fork, UT (US); Rick Allen Hamilton II, Charlottesville, VA (US); Alexandre Polozoff, Bloomington, IL (US)

Correspondence Address: IBM CORPORATION;C/O DARCELL WALKER, ATTORNEY AT LAW, 9301 SOUTHWEST FREEWAY, SUITE 250, HOUSTON, TX, 77074, US

(21) Appl. No.: 11/242,668

(22) Filed: Oct. 4, 2005

(51) Int. Cl. H04M 3/00

(52) U.S. Cl. 455/420; 455/418

(57) ABSTRACT

The user of a mobile device such as a cellular telephone can locate a lost or misplaced telephone by remotely adjusting the volume of the ring tone such that it is audible enough to for the user to hear it. The user will be able to call his/her own device. Once connected to the device, the user will be provided with the option to remotely change their ringer tone (e.g., from vibrate or low ringer volume to high ringer volume). Another feature is that the device will be able to provide information about its physical location in the event the owner is not in the same proximate area of the device. Third, the device will also have an emergency amount of power reserved exclusively for this retrieval process.

### FIELD OF THE INVENTION

This invention relates to a method and system that locates a mobile device and in particular to a method and system that enables the owner of a device to locate the device by remotely reconfiguring ring options on a mobile device. This invention further relates to a method and system that gives the owner of a remote device the ability to automatically configure certain mobile device properties and activate other device functions to facilitate finding the misplaced mobile device. Included in the system is the ability to guarantee a predetermined amount of battery capacity to ensure the system will work.

### BACKGROUND OF THE INVENTION

The telephone is one of the main means of communication used today. Throughout the world, the telephone provides people, businesses, governmental agencies and virtually all other entities with the capability to instantly communicate with each other. The telephone has evolved from just a device used for verbal/oral communication to a device that is used to transmit video and text messages. In addition, the actual telephone device has changed over time. Some of the original telephones comprised large bases with rotary dials and large hand held pieces through which a person would talk and listen. Today, the some telephone designs are one-piece modules through which a person dials numbers, talks and listens. In addition, the communication networks that link different telephones together have also changed. Historically, a telephone network comprised a telephone connected to a central switching box/location. These switching locations were connected through a network of cables. Many of these communication cables were large lines that contained many small communication wires that carried the telephone information. Today, telephone communications are much more sophisticated than the conventional telephone networks. The basic telephone network with a telephone being connected to a switching box does still exist. However, because of the variety of telephones that are in use, there are also other communication network configurations that included the basic telephone network and other communication means.

One reason for the complex communication network is the use of the many different telephones today. A main means of telephone communication today is the over air (wireless) communication. This wireless communication is accomplished through the use of a cellular telephone commonly known as a ‘cell phone’. With this form of communication, there is no physical connection between an individual telephone and a communication switching location. Instead, the telephone communicates over air with a communication tower that directs the call to the desired location. Today, a typical telephone network comprises these communication towers and the conventional switching stations. A person can call a wireless telephone from a conventional telephone. The call will be routed to the conventional switching station. Once it is determined that the called number is a wireless telephone, the call is routed via communication from the switching station to the communication tower for that cellular telephone. The communication then routes the call to the identified number of the cellular telephone.

The loss of cellular telephones and other mobile devices is a significant problem worldwide. In Korea it is estimated that 1 million cellular telephones are annually lost. Tens of thousands of cellular telephones are left in taxicabs yearly according to a nine-nation study of leading taxicab companies. In one study conducted by Gartner Group, they found that 25 to 30 percent of cellular telephones lost in airports are never recovered. Clearly and in the LAX airport alone, 4800 cellular telephones are collected each year. Continental Airlines also finds about 4800 telephones left behind in their airplanes on an annual basis. Clearly, the loss of cellular telephones is a worldwide problem representing a huge cost to consumers to replace.

When a person misplaces their cellular telephone, a typical way to recover the device is to call its number. The ring tone will give the owner an indication of the telephone location. Although this method works in many situations, the owner must be in the general vicinity of the telephone to hear the ring tone. If the telephone is in another location, this approach will not work. A second drawback to this approach is that many people set the ring tone of the telephone to vibrate or silent. This practice is common so that the ring tone will not disturb other people. If the ring tone is set very low or is not audible, again the owner will not be able to use this traditional approach to locate their misplaced telephone.

In other approaches to recovering a lost telephone, many cell phone users rely on good Samaritans to return their lost telephones. A passerby who finds a phone can turn on the phone and if it does not have a password lock, they can look for owner information if the phone contains it. Otherwise, they can call some people in the address book in an attempt to find the phone's owner. Other methods to locate the phone involve calling the telephone and seeing if anyone answers. If someone does answer and is willing to talk to you the phone might be recovered.

Many times, a cell telephone user knows approximately where they left the phone or at least has a good idea of the location. In this case, the user will return to that location, look around and call the phone to see if they can hear the phone's ring. Several problems with this method occur based on the following preconditions:

Is the telephone turned on?

Does the phone have enough of a charged battery to ring?

Is the telephone in silent or vibrate mode?

Is the telephone's ring tone distinguishable?

What is needed is a better way to assist consumers in recovering their cellular telephones when they become lost. This solution would enable the owner/user to locate a cellular telephone when the ring tone is inaudible and when the telephone is not in the immediate vicinity of the owner. Further, this solution would enable to the telephone device to maintain enough power to operate until found by the owner.

### SUMMARY OF THE INVENTION

It is an objective of the present invention to provide a method and system to enable the owner/user of a cellular telephone to locate a misplaced telephone device.

It is a second objective of the present invention to provide a method and system to remotely adjust the ring tone of a misplaced device.

It is a third objective of the present invention to provide a device with the capability to reserve an emergency amount of power to be used only for the purpose of locating a device when it has been misplaced.

It is a fourth objective of the present invention to provide a method and system that will enable a misplaced device to determine its physical location and relay that information to the owner/user of the device.

It is a fifth objective of the present invention to provide a device that can only be reactivated by the owner of the device once that device has been found.

The proposed invention aims to provide cellular telephone users with a locating option which will enable the telephone 1) to have enough battery capacity to perform the emergency locating option, and 2) will automatically change (if necessary) the telephone profile options from vibrate, silent, low volume, to a high volume unique ring tone. Cellular telephone users will be provided with a locating option which will allow them to either call and manually change the cell phone ring tone and volume temporarily to facilitate the locating of the cell phone or choose an automatic phone location option.

In the proposed invention, the cell phone user will be able to call their own cell phone much like they can do with most cell phone providers to remotely retrieve voice mail. Once connected to the cell phone provider, the user will enter a password, just as when retrieving voice mail, and then the user will be provided with the option to remotely change their ringer tone (e.g., from vibrate or low ringer volume to high ringer volume). Another option would be to provide a “locate” option which will make the cell phone beep loudly so the cell phone user can locate it.

In some cases, the cell phone battery might get drained while the phone is lost. Accordingly, even with the proposed invention, it would be difficult for the cell phone user to locate the telephone. Another optional feature to be added to cell phones with the locate option would be to allow for an emergency amount of power which can only be used for cell phone locating purposes. The cell phone could then be remotely located via the aforementioned remote find feature.

In the method of the present invention, the user would call the number of the misplaced telephone device. If no one should answer, once the voice mail option answers the call, the user would input a code to activate the device locator service. Next, the owner would validate their identity with a personal identity code. After validation of this code, the owner will receive a prompt to enter a ring tone volume adjustment parameter. At that point, the ring tone volume would be increased such that the tone will be audible upon a call to the telephone. The audible ring tone will make the telephone easier to locate. This ring tone adjustment can occur remotely and will increase the ring tone even if the device is currently set on ‘silent’ or ‘vibrate’ options.

### DESCRIPTION OF THE DRAWINGS

FIG. 1 is a configuration for a cellular telephone network.

FIG. 2 is a conventional display screen for a cellular telephone device.

FIG. 3 is a conventional keypad for a cellular telephone device.

FIG. 4 is a flow diagram of the basic steps performed by a cellular telephone device in accordance with the present invention.

FIG. 5 is a flow diagram of the basic steps performed by the owner/user of a cellular telephone when attempting to locate a misplaced telephone in accordance with the present invention.

FIG. 6 is a flow diagram of the steps to adjust the ring tone of a cellular telephone device in order to locate that device in accordance with the present invention.

FIG. 7 is a flow diagram of the steps to identify the physical location of a misplaced cellular telephone device in accordance with the present invention.

### DETAILED DESCRIPTION OF THE INVENTION

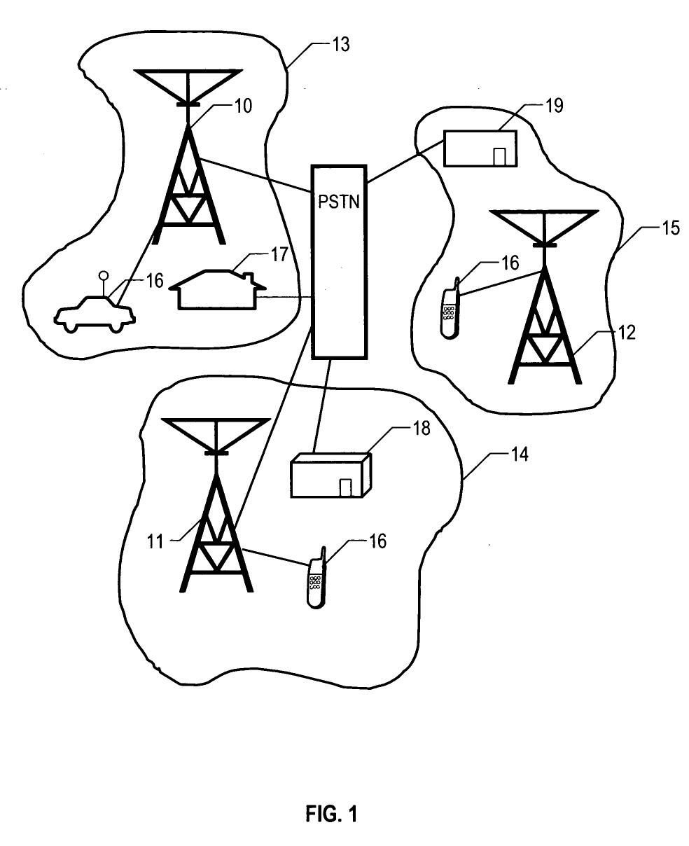

The present invention comprises a method and system for retrieving a portable device such as a cellular telephone when the device is in a mode such that it can not generate an audible sound to alert the user to its location. The invention further provides features that will enable the portable device to transmit information to the user related to the location of the remote device such that the user can retrieve the device. Referring to FIG. 1, shown is telephone communication network incorporating both wireless and physical connections. Communication towers 10, 11 and 12 provide the connection means for mobile and wireless devices within this network. Each tower has a defined area in which the tower provides wireless telephone connections. As shown, tower 10 serves area 13, tower 11 serves area 14 and tower 12 serves area 15. Within a defined area, the tower will facilitate the connection of wireless devices to the telephone network. This connection will enable a wireless device 16 to connect to other wireless devices or to conventional and stationary devices such as homes 17, factories 18 and office buildings 19. As shown, stationary devices can connect directly to the PSTN (Public Switched Telephone Network). The towers are also connected to the PSTN. This connection enables the wireless device to connect to a stationary device.

The system of the present invention is implemented with the larger communication network shown in FIG. 1. The system of the present invention comprises a wireless telephone communication network that has communication towers such as 10. Each tower has associated software that controls the functioning of the tower. This software receives a call connection attempt, determines the location of the desired number for the connection and makes the call connection.

The system of the present invention incorporates a software module in the communication software that controls the operation of the control tower. This software module of the present invention will monitor the calling activity occurring at the tower. This activity will include the number of wireless calling attempts occurring at that tower. This monitoring process will be on a constant basis. The system of the present invention also comprises the wireless device that is used to make the call attempt. Within the wireless device will be a display to inform the user of the calling availability at that time. Current wireless devices display information that indicates signal strength of a call. The present invention will also provide information on the availability to connect a calling attempt. This information will be in the form of an icon on the display screen of the wireless device.

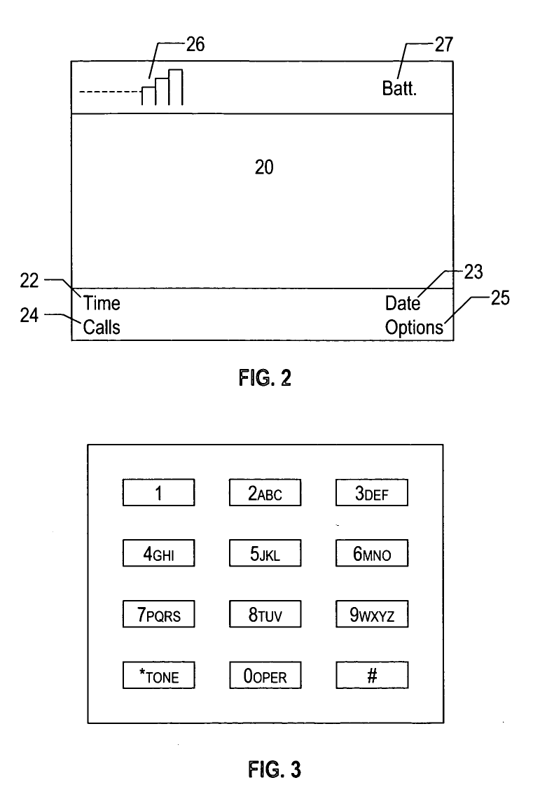

FIG. 2 illustrates a conventional display screen for a wireless calling device. As shown, the device display screen 20 can have information in the form of text data or icons that relay certain standard information. This screen has an icon 21 that conveys the amount of power available in the battery of the device. The current time 22 and the date 23 can be illustrated with text information. Other icons on the display screen, such as calls 24 and options 25, function in a manner similar to the desktop of a computer screen. Also indicated is the signal strength 26 of a signal coming to the device and the battery strength 27 of the device. As will be discussed later, the battery strength is crucial to the operation of the invention. These icons enable the user to access other options and data on other screen displays within the device. FIG. 3 illustrates the keypad for a wireless device. This keypad is the conventional pad used by touch-tone telephones.

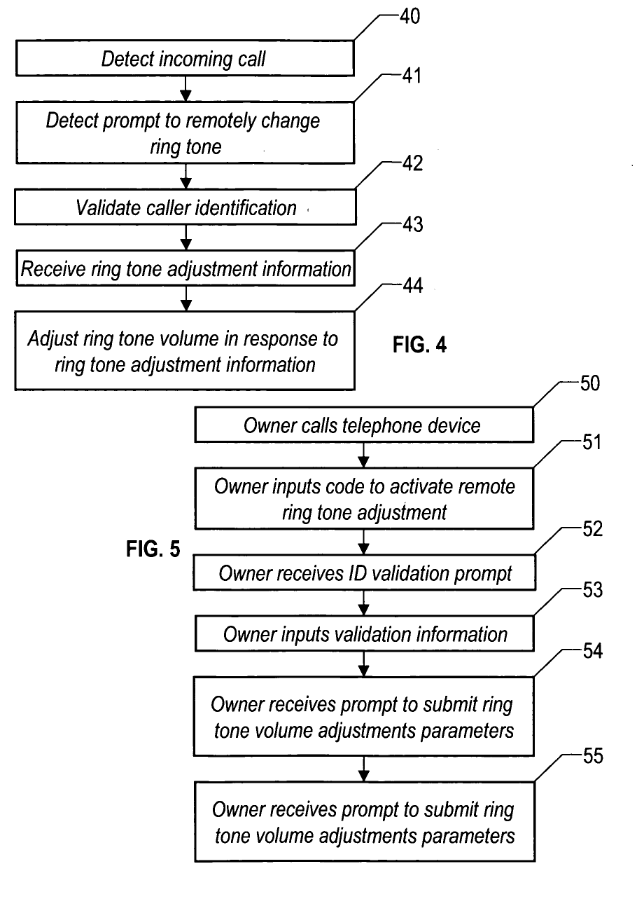

As mentioned, the present invention involves the ability to remotely change the ring tone when the tone is set to vibrate, silent or a low ring volume. FIG. 4 illustrates a flow diagram of the steps implemented by the telephone device in the present invention. In step 40, the method detects an incoming call to the device. This detection is the same as if someone is making a routine call to the device user. Step 41 detects a prompt to remotely adjust the ring tone of the telephone device. In the implementation of this step, when the call remains unanswered, the voice mail feature will answer the call. When the voice mail feature is activated, the user would enter a ring tone adjustment code. The method would detect this entered code as a prompt to change the ring tone of the device. Once the telephone detects this ring tone prompt, step 42 validates the identity of the user. This step could prompt the user to enter a pass code that identifies the user with this particular telephone device. At the validation of the caller identification, step 43 prompts the user to submit an adjusted ring tone volume. This submission can be in the form of the selection of a volume level based on a 1 to 10 scale, with 10 being the highest volume. This selection would override the current ring tone volume setting even if that current setting is ‘vibrate’ or ‘silent’. Once the user has entered a desired ring tone volume setting, step 44 adjusts the ring tone volume of the telephone device to that selected ring tone volume level.

FIG. 5 illustrates a flow diagram of the steps performed by the user in the implementation of the present invention. In step 50, the owner of a lost telephone device calls the number of that telephone device. Upon an answer by the telephone device voice mail feature, in step 51, the owner inputs a code to activate the remote ring tone volume adjustment feature. After the user enters the code to activate the ring adjustment feature, in step 52, the owner receives prompt to supply the user identification for validation. In step 53, the owner supplies this user identification validation code. The owner will then receive a prompt to supply a ring tone adjustment volume setting in step 54. As mentioned, the adjustment codes could be a numeral selection. In step 55, the owner submits the adjustment code for the ring tone volume.

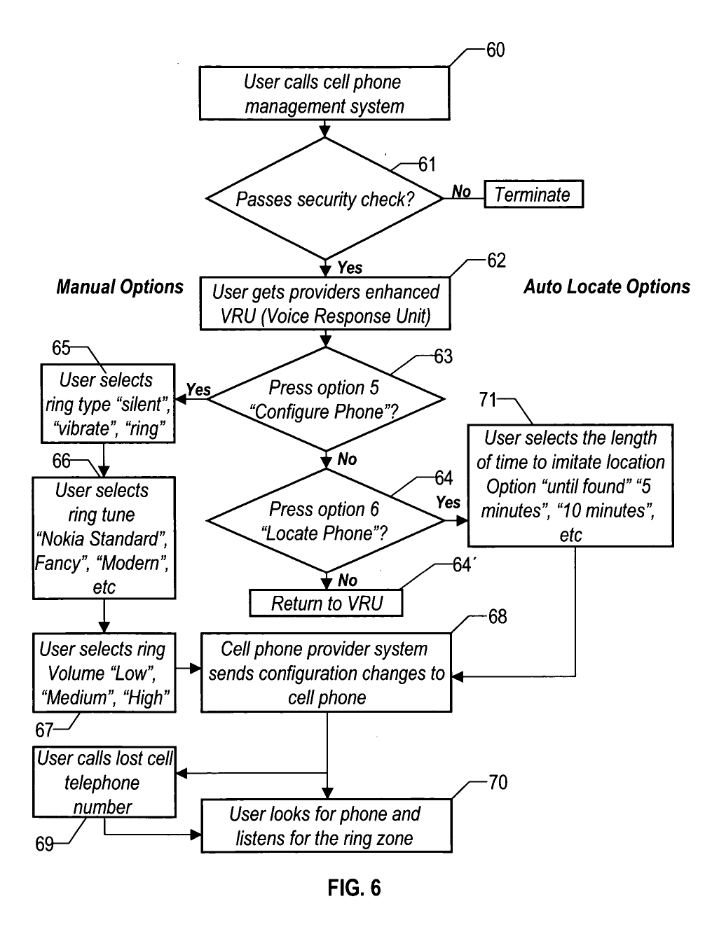

FIG. 6 shows a typical process flow for someone who is trying to locate their telephone using the technology of the present invention. In step 60 of this process, the user calls a cellular telephone management system. This management system can be an existing Voice Response Unit (VRU) hosted by the cell phone company. Before establishing communication with the VRU, the user passes a security check in step 61. In this security check, the user validates his or her identity. This identity can be in the form of a personal password or code that is associated solely with that person and specific telephone number for that device. The VRU performs a comparison to verify that the person making the communication is the owner/user of the device. If the security check results in the validation of the person making contact as the user, communication is established between the user and the VRU in step 62. If the security check is invalid, the process will terminate in the termination box. Once the user has established communication with the VRU, the user can choose between a manual option and an automated option to adjust the telephone volume and locate the telephone. In step 63, the user can select the manual option. As shown, the user can make this selection by pressing a number (number 5) on a touchtone telephone. If the user prefers the auto location option, in step 64 they can press a different key (number 6). If the user decided not to complete this task at the present time, the user can abort the process by not selecting either option. If the user decides to abort the process, the method moves to step 64′, which will return the user to the VRU. At this point the user can terminate the process if desired.

As shown in FIG. 6, choosing the manual option moves the process to the left fork and choosing the auto locate option moves the process to the right fork. The manual option allows the user to manually change the ring tone, melody, and volume. The auto locate option will automatically change the ringer to settings ideal for locating (highest volume, unique ring tone, etc).

Referring to the manual option process, once the user selects this option in step 63, the user selects the type of ring in step 65. Because this process enables the user to adjust the ring tone for other purposes than to locate a misplaced telephone, the user has various ring tone options from which to choose (vibrate, silent and ring). With this particular implementation, the user will choose the ring option. Once the user selects the type of ring tone, in step 66, the user selects the tune of the ring. As shown, the tune can vary and can include options such as “Nokia Standard”, “Fancy” or “Modern”. In step 67, the user can select the ring volume, which can range from low to medium to high.

The completion of step 67 completes the manual ring tone adjustment process. At this point, in step 68, the cell phone provider system sends the configuration change based on the information gathered in steps 65, 66, and 67 to the actual telephone identified by the user. Once the telephone has incorporated the configuration changes, the user can call the telephone in step 69. In an alternative approach, at the completion of the incorporation of the configuration changes, the network can automatically initiate the call to the telephone device for the user. Since the new configuration has an audible ring tone, in step 70 the user can listen for the telephone in the ring tone zone.

Referring again to step 64, the user can also select an auto locate option. In the auto locate option, step 71, there is a setting which allows the user to specify how long the system will enable the locate options. Possible settings range from 1 iteration to a permanent state change (that is until it is found and switched back). A user could for example specify how long the phone should ring in its locate state, or how many times to go through a cycle where a cycle is defined as a ring and pause period. A delayed ring/pause period could be helpful for scenarios where a cell phone battery is near depletion. In one implementation, a custom ring tone can be set with a “.wav” style source so that the phone can advertise that it is lost. Where this is not desirable, regular polyphonic ring tones can be used. Once the configuration is complete, the process moves to step 68 where the cell phone provider system sends the configuration change based on the information gathered in step 71. As with the manual option, once the telephone has incorporated the configuration changes, the user can call the telephone in step 69. Since the new configuration has an audible ring tone, in step 70 the user can listen for the telephone in the audible ring tone zone. The ring tone zone is the area surrounding the telephone where it is reasonable for one to be able to hear the ring of the telephone. This area can vary and can be affected by the noise environment around the telephone.

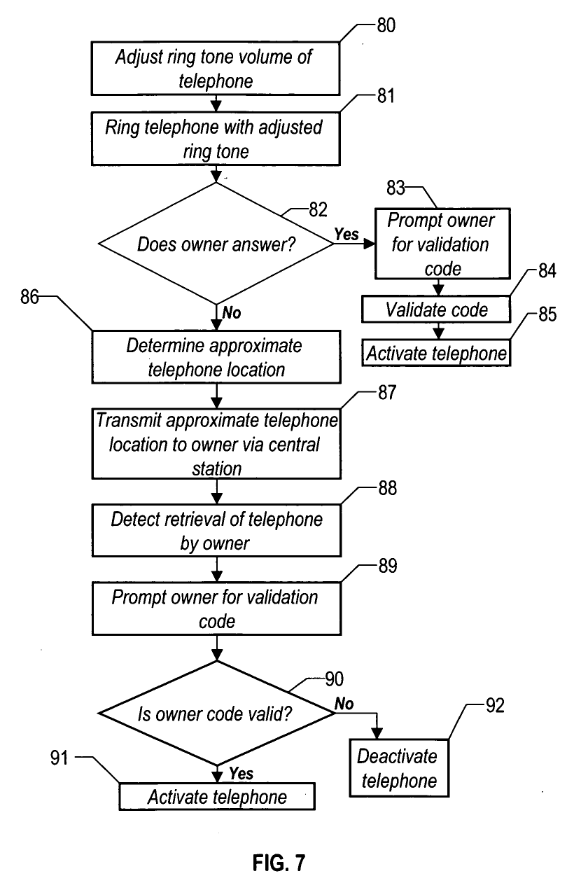

Referring to FIG. 1, there are situations when the owner may be at home 17, but has left their telephone in office building 19. In this case, the method described in FIG. 6 will not enable the owner to use an adjusted ring tone to locate the telephone because the proximity (or lack thereof) of the owner to the telephone. The owner is outside the ring tone zone of the telephone. FIG. 7 illustrates the steps to identify the physical location of a misplaced cellular telephone device. The physical identification along with the adjusted ring tone will increase the ability of the owner to locate a misplaced telephone.

The process begins with the adjustment of the ring tone volume. In step 80, the user can adjust the ring tone volume as described in FIG. 6. Next the user calls the telephone device in step 81. Step 82 determines whether there is an answer of the called telephone. If someone does answer, this means that the telephone was heard. At this point, steps 83, 84 and 85 verify that the one answering the telephone is the owner of the telephone. Step 83 prompts for the owner validation code. Again this code will be unique for the owner. Once the code is input into the telephone, step 84 validates this code against the known code of the owner. If the inputted code matches the owner code for that telephone, step 85 activates the telephone such that the owner can use the telephone in a normal manner. It is necessary to activate the telephone for security purposes. The activation of the VRU in FIG. 6 causes the telephone to go into a security state. This activation informs the telephone that the owner is looking for it. In addition to the ring tone, the mobile device can also exhibit a visual indicator such as a flashing battery. This visual indicator can be of more importance in environments having little light. In step 82, anyone can answer the telephone. However, it is necessary to ensure that the one answering the telephone is the telephone's owner. Therefore, before the telephone returns to normal operations, it is necessary to deactivate the voice recovery mode of the telephone.

Referring again to step 82, if no one answers the telephone, the telephone interprets this as a lost telephone at a location that is not in the proximity of the owner. As a result, the telephone will attempt to identify its location and send that information to the owner. Step 86 determines the approximate physical location of the telephone. One specific implementation to physically identify a telephone location is the use of Mesh Network and Triangulation Location Techniques. This approach involves using nearby telephones or telephone towers to help lead a user to his lost phone. In such an implementation where the telephone is known or believed to be lost, the phone could broadcast its coordinates to a centrally hosted system (i.e., the cellular carrier) that would release that information to the owner after logging into the system. Coordinate information could be mapped to well known electronic maps and an address could be derived from said information. The coordinates that the telephone transmits could be based on either a triangulation of registered cell towers 10, 11 and 12 and related signal strengths or via GPS coordinates as some phones are beginning to have. Alternatively, a phone which is in a “Auto Locate” state could broadcast by means of Bluetooth or other radio/wireless means a signal to other nearby phones which would in succession allow an owner to follow the audible bread crumb to his lost phone.

Referring again to step 86, once there has been a determination of the telephone location, this information is transmitted to the owner via a central station in step 87. This process could be in the form a telephone call to the owner. In step 88, the telephone would detect its retrieval. This detection could be by the calling the telephone, then answering it. At this point, it is necessary to validate that the person answering the telephone is the owner. Step 89 will prompt for the owner validation code. Step 90 determines if this code is correct. This determination could be by comparing the inputted code to the known code of the owner. If the codes match, the validation is complete. At this point, step 91 activates the telephone similar to step 85. If the codes do not match, step 92 keeps the telephone in the deactivated state that it entered when the volume adjustment process began in step 80. As previously discussed, this deactivated state is in regard to normal use of the telephone. In an example, a telephone located in office building 19 is closest to tower 12. This determination could be based on signal strength of the telephone to the tower. From this information, the user may realize that the tower is generally near the office building. At that point, the owner can go to the office building, call the telephone device and with the adjusted ring tone hear and retrieve the telephone. As previously mentioned, the mobile device can also exhibit a visual indicator such as a flashing battery. This visual indicator can be of more importance in environments having little light.

With any implementation of the device of the present invention, the device has to have power. When a telephone is lost for a significant period of time, the battery charge will be depleted. Part of the invention includes additional functionality be added to the cell phone. Two major changes/additions are needed. The first change is the ability to reserve a certain amount of battery power that can only be used during an “auto Locate” state change. This reserve battery supply could be implemented electronically or by using separate battery supplies. Electronic reserves can be accomplished by displaying a zero percent battery indication when there is in fact 2% in reserve. At that point the phone could be forced off and normal indications to the user would be that the phone was indeed out of power. The amount of battery power that is held in reserve could be a user defined setting on the phone. Optionally, a second smaller reserve battery could be installed just for this purpose.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

I claim:

1. A method to locate a mobile device by remotely adjusting the audible settings of the device comprising the steps of:
establishing a first communication with the mobile device;
selecting an audio parameter configuration for that mobile device;
reconfiguring the audible parameters of the mobile from a locate remote to the device such that an audible volume of the device is increased;
attempting to establish a second communication with the device such that the device produces an audible sound at the increased volume; and
searching for and retrieving the mobile device based on the a determination of the location of the audible sound produced by the device.

2. The method as described in claim 1 wherein said establishing a first communication with the mobile device comprises validating the identity of one attempting to establish communication as the owner of the mobile device and connecting the owner to the mobile device via an enhanced voice recovery unit.

3. The method as described in claim 2 further comprising before said audio parameter selecting step, the step of selecting a manual or automated locate option.

4. The method as described in claim 3 wherein said audio parameter selecting step further comprises:
selecting a manual audio parameter selection option;
selecting an audio ring type; and
selecting a ring volume level.

5. The method as described in claim 4 wherein said reconfiguring step further comprises submitting the selected audio parameters to mobile device via a service provider, receiving the parameters at the mobile device and reconfiguring the audio parameters of the device based on the received audio parameters

6. The method as described in claim 4 wherein said attempting to establish a second communication step comprises calling the number of the device.

7. The method as described in claim 3 wherein said audio parameter selecting step further comprises:
selecting an automated audio parameter selection option;
selecting a length of time for the mobile device to operate in an automated locate state; and
selecting operation parameters for the mobile device while in this automated locate state.

8. The method as described in claim 2 further comprising before said step to attempt to establish a second communication the step of determining a general physical location of the mobile device.

9. The method as described in claim 8 wherein said determining a general physical location further comprises determining physical coordinates and transmitting these coordinates to the owner.

10. The method as described in claim 2 further comprising before said step to attempt to establish a second communication, the steps of:
detecting an attempt to reconfigure audible parameters of the mobile device;
initiating a physical location approximation routine in the mobile device to determine the approximate physical coordinates of the mobile device;
transmitting the determined physical coordinates to the owner via the established communications between the owner and the mobile device; and
initiating a visual location indicator at the mobile device

11. The method as described in claim 10 wherein said step to determine the physical coordinates of the mobile device further comprise identifying the physical location of telephone towers and determining the determining a position of the mobile device in relation to the location of the identified telephone towers.

12. The method as described in claim 10 wherein said step to determine the physical coordinates of the mobile device further comprises the use of a global positioning satellite system.

13. A computer program product in a computer readable medium to locate a mobile device by remotely adjusting the audible settings of the device comprising:
instructions for establishing a first communication with the mobile device;
instructions for selecting an audio parameter configuration for that mobile device;
instructions for reconfiguring the audible parameters of the mobile from a locate remote to the device such that an audible volume of the device is increased;
instructions for attempting to establish a second communication with the device such that the device produces an audible sound at the increased volume; and
instructions for searching for and retrieving the mobile device based on the a determination of the location of the audible sound produced by the device.

14. The computer program product as described in claim 13 wherein said instructions for establishing a first communication with the mobile device further comprise instructions for validating the identity of one attempting to establish communication as the owner of the mobile device and connecting the owner to the mobile device via an enhanced voice recovery unit.

15. The computer program product as described in claim 14 wherein said audio parameter selecting instructions further comprise instructions for:
selecting a manual audio parameter selection option;
selecting an audio ring type; and
selecting a ring volume level.

16. The computer program product as described in claim 14 wherein said audio parameter selecting instructions further comprise instructions for:
selecting an automated audio parameter selection option;
selecting a length of time for the mobile device to operate in an automated locate state; and
selecting operation parameters for the mobile device while in this automated locate state.

17. The computer program product as described in claim 14 further comprising before said instructions to attempt to establish a second communication:
instructions for detecting an attempt to reconfigure audible parameters of the mobile device;
instructions for initiating a physical location approximation routine in the mobile device to determine the approximate physical coordinates of the mobile device; and
instructions for transmitting the determined physical coordinates to the owner via the established communications between the owner and the mobile device.

18. The computer program product as described in claim 17 wherein said instructions to determine the physical coordinates of the mobile device further comprise instructions for identifying the physical location of telephone towers and determining the determining a position of the mobile device in relation to the location of the identified telephone towers.

19. The computer program product as described in claim 17 wherein said instructions to determine the physical coordinates of the mobile device further comprise the use of a global positioning satellite system.

20. A system to locate a wireless mobile device by remotely adjusting the audible settings of the device comprising:
a voice response unit capable of establishing communication with a wireless mobile device or a hardwired device;
a program within the wireless mobile device capable of receiving signals via said voice response unit and reconfiguring audible parameters of the mobile device in response to received signals;
a program within the wireless mobile device capable of detecting an attempt to reconfigure audible parameters within the device, determining coordinates corresponding to an approximate physical location of the device and transmitting these coordinates to an owner of the mobile device via the voice response unit;
a communication device used by an owner of the mobile device to establish communication with the mobile device via the voice response unit, the communication device being capable to transmit signals to the mobile device for the purpose of reconfiguring the audible parameters in the mobile device; and
a communication network to establish communications between said communication device, said voice response device and the mobile device.
